(19) United States
(12) Patent Application Publication
(10) Pub. No.: US 2026/0339623 A1
(43) Pub. Date: Oct. 29, 2026

(54) REFORMED - REFINING CODE GENERATION MODELS THROUGH SELF-GUIDED FEEDBACK

(71) Applicant: International Business Machines Corporation, Armonk, NY (US)

(72) Inventors: Oishik Chatterjee, Kolkata (IN); Pooja Aggarwal, Bengaluru (IN); Sidharth Sinha, Pimpri-Chinchwad (IN)

(21) Appl. No.: 19/189,959

(22) Filed: Apr. 25, 2025

(51) Int. Cl. G06F 8/35

(52) U.S. Cl. CPC G06F 8/35

(57) ABSTRACT

A system includes a processor that executes computer executable components stored in a memory. The computer executable components can include a code generation component that prompts a student model to generate multiple code responses, each comprising a candidate solution to a given coding task. The computer executable components can further include an evaluation component that utilizes a teacher model to assess correctness of each of the code responses. The computer executable components can further include a feedback component that introduces errors into correct code responses to generate corresponding incorrect versions, and rectifies incorrect code responses to generate corresponding correct versions. The computer executable components can include a pairing component that compiles the correct and incorrect versions into a dataset of code pairs. The computer executable include can further comprise a tuning component that fine-tunes the student model using direct preference optimization based on the dataset.

### TECHNICAL FIELD

The subject disclosure relates to refinement of large language model code generation, e.g., improving the performance of large language models on programming tasks by refining training through feedback-driven optimization techniques.

### BACKGROUND

Code generation using large language models (LLMs) can be a useful tool to assist in writing and understanding software. Large language models can produce syntactically correct code snippets in response to natural language prompts. Despite their capabilities, current systems often struggle with producing consistently correct or efficient solutions, especially for complex tasks that require multi-step reasoning or domain-specific knowledge.

The current techniques for improving large language model-based code generation heavily rely on test cases as a primary source of feedback. While effective, this dependency can be limiting, especially when test cases are unavailable or insufficient to fully validate functional correctness. Other approaches have focused on advanced prompting strategies, which often involve iterative and resource-intensive interactions with large models during inference. These methods, while promising, are not cost-effective and may still fail to provide comprehensive feedback for model training.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate training and refinement of code generation models through assessment, feedback, or preference-based optimization are provided.

According to an embodiment, a system can comprise a processor that executes computer executable components stored in memory. The computer executable components can comprise a code generation component that prompts a student model to generate multiple code responses, each comprising a candidate solution to a given coding task. The computer executable components can further comprise an evaluation component that utilizes a teacher model to assess correctness of each of the code responses. The computer executable components can further comprise a feedback component that introduces errors into correct code responses to generate corresponding incorrect versions, and rectifies incorrect code responses to generate corresponding correct versions. The computer executable components can comprise a pairing component that compiles the correct and incorrect versions into a dataset of code pairs. The computer executable components can further comprise a tuning component that fine-tunes the student model using direct preference optimization based on the dataset.

According to another embodiment, a computer-implemented method can comprise prompting, by a system operatively coupled to a processor, a student model to generate multiple code responses, each comprising a candidate solution to a given coding task. The computer-implemented method comprises utilizing, by a system, a teacher model to assess correctness of each of the code responses. The computer-implemented method further comprises introducing, by a system, errors into correct code responses to generate corresponding incorrect versions. The computer implemented method can further comprise rectifying, by the system, incorrect code responses to generate corresponding correct versions. The computer implemented method can further comprise compiling, by the system, the correct and incorrect versions into a dataset of code pairs. The computer implemented method can further comprise fine-tuning, by the system, the student model using direct preference optimization based on the dataset.

According to another embodiment, a computer program product comprising a computer readable storage medium having program instructions embodied therewith, the program instructions executable by a processor to cause the processor to prompt, by the processor, a student model to generate multiple code responses, each comprising a candidate solution to a given coding task. The program instructions can also cause the processor to utilize, by the processor, a teacher model to assess correctness of each of the code responses. The program instructions can also cause the processor to introduce, by the processor, errors into correct code responses to generate corresponding incorrect versions. The program instructions can further cause the processor to rectify, by the processor, incorrect code responses to generate corresponding correct versions. The program instructions can cause the processor to compile, by the processor, the correct and incorrect versions into a dataset of code pairs. The program instructions can also cause the processor to fine-tune, by the processor, the student model using direct preference optimization based on the dataset.

### BRIEF DESCRIPTION OF THE DRAWINGS

FIG. 1 illustrates example systems that can facilitate refinement of code generated by large language models in accordance with some embodiments described herein.

FIGS. 2 and 3 illustrate flow diagrams of example computer implemented methods that can facilitate refinement of code generated by large language models in accordance with some embodiments described herein.

FIG. 4 illustrates an example architecture for training a language model using feedback-based refinement in accordance with some of the embodiments described herein.

FIG. 5 illustrates an example process flow 500 for code sample generation and evaluation, in accordance with one or more embodiments described herein.

FIG. 6 illustrates an example process 600 for bug generation and incorrect code synthesis in accordance with one or more embodiments.

FIG. 7 illustrates an example process 700 for code rectification and iterative correction of incorrect code samples, in accordance with one or more embodiments.

FIG. 8 illustrates an example process 800 for preference dataset creation and model fine-tuning using direct preference optimization (DPO), in accordance with one or more embodiments

FIG. 9 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Large language models (LLMs) can generate source code for a wide variety of programming tasks. These models, often trained on extensive corpora of publicly available code and natural language, can produce code solutions in response to natural language prompts. However, current methods for refining such code generation models typically rely on the availability of unit test cases or ground truth code as feedback signals. Generating and collecting specific test cases for different tasks can be time intensive. Human annotation of data can be a tedious and expensive task.

Alternative prompting-based approaches attempt to bypass the need for test cases by iteratively querying large language models to provide evaluation or refinement feedback. While this reduces reliance on ground truth, these methods can introduce new limitations such as incurring high computational costs due to repeated inference calls and cascading errors. These approaches generally offer only marginal improvements. Additionally, these strategies can fail to offer an efficient way to improve performance of smaller, resource-efficient language models.

Due to the limitations described herein, there remains a need for improved systems and methods that enable smaller language models to learn from feedback without relying on traditional sources of supervision such as ground truth annotations or test cases. The system described herein introduces a feedback-driven training framework that leverages the capabilities of a larger teacher model to guide a smaller student model. The approach enables automated feedback generation and fine-tuning without requiring compilers or test infrastructure at training time, thereby offering a more efficient pipeline.

According to an embodiment, a system can include a processor that executes computer executable components stored in a memory. The computer executable components can include a code generation component that prompts a student model to generate multiple code responses, each comprising a candidate solution to a given coding task. The computer executable components can further include an evaluation component that utilizes a teacher model to assess correctness of each of the code responses. The computer executable components can further include a feedback component that introduces errors into correct code responses to generate corresponding incorrect versions, and rectifies incorrect code responses to generate corresponding correct versions. The computer executable components can include a pairing component that compiles the correct and incorrect versions into a dataset of code pairs. The computer executable include can further comprise a tuning component that fine-tunes the student model using direct preference optimization based on the dataset.

In various embodiments, the student model can be fine-tuned using reinforcement learning techniques to maximize its ability to generate correct code responses. A reinforcement learning technique can include preference-based methods that use pairwise comparisons between code samples to guide optimization. In some embodiments, the teacher model can be a larger pre-trained language model that provides evaluations and modifications without requiring explicit test cases or compiler execution. A teacher model can operate without access to ground truth labels or unit tests, relying instead on its own internal evaluation criteria.

In various embodiments, the code generation component can generate the code responses by prompting the student model at different temperatures. Temperature values can be sampled from a predefined range to introduce variation in an output. In some embodiments, a fixed number of samples can be generated per prompt, while in other embodiments the number can vary dynamically based on task complexity or confidence scores.

In some embodiments, the evaluation component can determine correctness based on criteria provided by the teacher model, including at least one of: syntax validity, logical accuracy, or functional correctness. Correctness can be determined without executing code, relying instead on static or inferred properties. In various embodiments, the evaluation can be based on natural language reasoning capabilities of the teacher model, which can identify likely semantic errors or omissions.

In various embodiments, the feedback component can generate the incorrect versions by introducing syntactic, logical, or semantic bugs into the correct code responses. In certain embodiments, the bug generation can be guided by prompting a teacher model to introduce a specific number or type of errors. In some embodiments, the feedback component can rectify the incorrect code responses by iteratively modifying the incorrect code responses until the teacher model evaluates them as correct. The rectification loop can be repeated until a correctness condition is satisfied, such as an affirmative evaluation from a teacher model.

In some embodiments, the tuning component can assign higher preference scores to the correct code responses as compared to the incorrect code responses during fine-tuning. Preference scores can be computed based on relative likelihoods, learned reward functions, or contrastive learning objectives. According to various embodiments, the dataset can include metadata describing differences between the correct and incorrect versions, including information relating to applied corrections. Metadata can be used to track transformation steps and can support interpretability or future model analysis. In various embodiments, the tuning component can update the student model iteratively based on comparisons between the correct and incorrect code responses. Fine-tuning can be performed using direct preference optimization to align the student model's outputs with those preferred by a teacher model.

Advantages of this system can include enabling more efficient training of smaller large language models through feedback, improving model accuracy without compiler-based validation, and lowering computational costs by avoiding repeated inference calls or multi-agent prompting during training.

According to some embodiments, the above-described computer system may be implemented as a computer-implemented method or as a computer program product.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

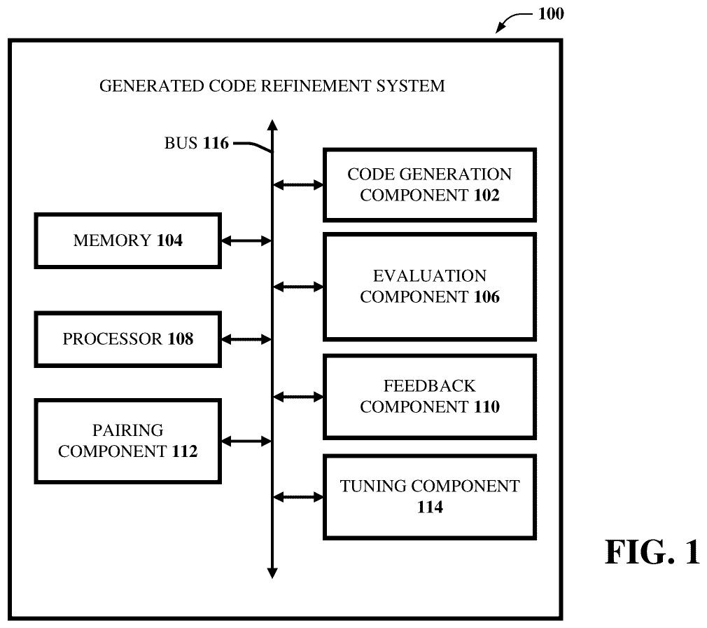

FIG. 1 illustrates an example system 100 for facilitating refinement of code generated by large language models in accordance with some embodiments described herein. System 100 uses a code generation component 102, an evaluation component 106, a feedback component 110, a pairing component 112, and a tuning component 114. The code generation component 102 prompts a student model to generate multiple code responses, each comprising a candidate solution to a given coding task. The evaluation component 106 utilizes a teacher model to assess correctness of each of the code responses. The feedback component 110 introduces errors into correct code responses to generate corresponding incorrect versions, and rectifies incorrect code responses to generate corresponding correct versions. The pairing component 112 compiles the correct and incorrect versions into a dataset of code pairs. The tuning component 114 fine-tunes the student model using direct preference optimization based on the dataset.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise a code generation component 102, a memory 104, an evaluation component 106, a processor 108, a feedback component 110, a pairing component 112, a tuning component 114, and a system bus 116.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to the refinement of code generated by large language models by enabling more efficient training of smaller large language, improving model accuracy without compiler-based validation, and lowering computational costs.

System 100 may include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the code generation component 102, the evaluation component 106, the feedback component 110, the pairing component 112, and/or the tuning component 114) to perform one or more actions. In some embodiments, the memory 104 can store computer-executable components (e.g., the code generation component 102, the evaluation component 106, the feedback component 110, the pairing component 112, and/or the tuning component 114).

The system 100 and/or a component thereof as described herein can be communicatively, electrically, operatively, optically, and/or otherwise coupled to one another via a bus 116. The bus 116 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the student model can be fine-tuned using reinforcement learning techniques to maximize its ability to generate correct code responses. A reinforcement learning technique can include preference-based methods that use pairwise comparisons between code samples to guide optimization. In some embodiments, the teacher model can be a larger pre-trained language model that provides evaluations and modifications without requiring explicit test cases or compiler execution. A teacher model can operate without access to ground truth labels or unit tests, relying instead on its own internal evaluation criteria.

In various embodiments, the code generation component 102 can generate the code responses by prompting the student model at different temperatures. Temperature values can be sampled from a predefined range to introduce variation in an output. In some embodiments, a fixed number of samples can be generated per prompt, while in other embodiments the number can vary dynamically based on task complexity or confidence scores.

In some embodiments, the evaluation component 106 can determine correctness based on criteria provided by the teacher model, including at least one of: syntax validity, logical accuracy, or functional correctness. Correctness can be determined without executing code, relying instead on static or inferred properties. In various embodiments, evaluation can be based on natural language reasoning capabilities of the teacher model, which can identify likely semantic errors or omissions.

In various embodiments, the feedback component 110 can generate the incorrect versions by introducing syntactic, logical, or semantic bugs into the correct code responses. In certain embodiments, the bug generation can be guided by prompting a teacher model to introduce a specific number or type of errors. In some embodiments, the feedback component 110 can rectify the incorrect code responses by iteratively modifying the incorrect code responses until the teacher model evaluates them as correct. The rectification loop can be repeated until a correctness condition is satisfied, such as an affirmative evaluation from a teacher model.

In some embodiments, the tuning component 114 can assign higher preference scores to the correct code responses as compared to the incorrect code responses during fine-tuning. Preference scores can be computed based on relative likelihoods, learned reward functions, or contrastive learning objectives. According to various embodiments, the dataset can include metadata describing differences between the correct and incorrect versions, including information relating to applied corrections. Metadata can be used to track transformation steps and can support interpretability or future model analysis. In various embodiments, the tuning component 114 can update the student model iteratively based on comparisons between the correct and incorrect code responses. Fine-tuning can be performed using direct preference optimization to align the student model's outputs with those preferred by a teacher model.

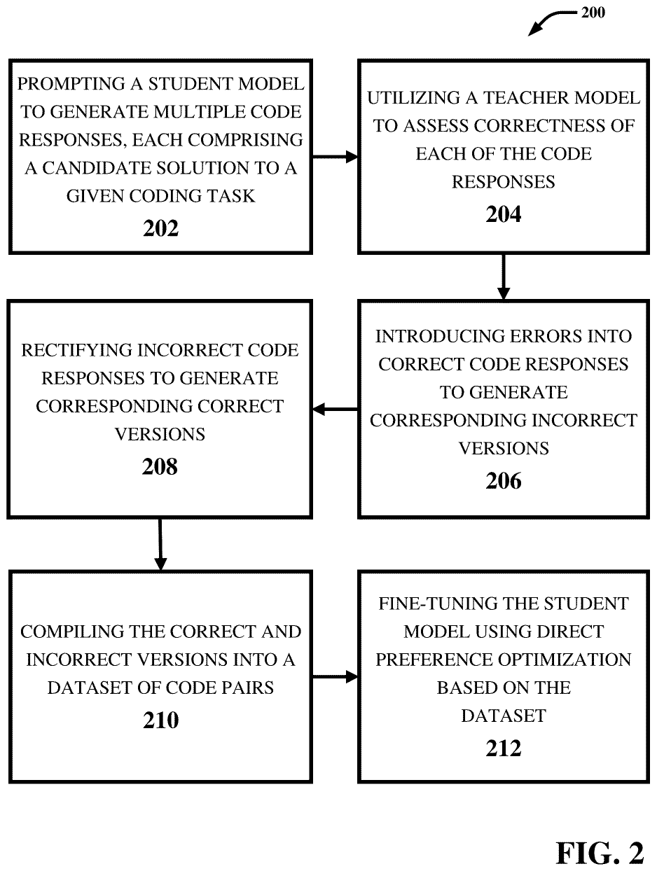

FIG. 2 illustrates a flow diagram of a method 200 that can facilitate refinement of code generated by large language models in accordance with some embodiments described herein, such as the system 100 of FIG. 1. While the method 300 is described relative to the system 100 of FIG. 1, the method 200 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 202, the method 200 includes prompting a student model to generate multiple code responses, each comprising a candidate solution to a given coding task. The method 200 can use a system operatively coupled to the processor (e.g., code generation component 102) to prompt a student model to generate multiple code responses, each comprising a candidate solution to a given coding task.

At 204, method 200 includes utilizing a teacher model to assess correctness of each of the code responses. The method 200 can use a system operatively coupled to the processor (e.g., evaluation component 106) to utilize a teacher model to assess correctness of each of the code responses.

At 206, method 200 includes introducing errors into correct code responses to generate corresponding incorrect versions. The method 200 can use a system operatively coupled to the processor (e.g., feedback component 110) to introduce errors into correct code responses to generate corresponding incorrect versions.

At 208, method 200 includes rectifying incorrect code responses to generate corresponding correct versions. The method 200 can use a system operatively coupled to the processor (e.g., feedback component 110) to rectify incorrect code responses to generate corresponding correct versions.

At 210, method 200 includes compiling the correct and incorrect versions into a dataset of code pairs. The method 200 can use a system operatively coupled to the processor (e.g., pairing component 112) to compile the correct and incorrect versions into a dataset of code pairs.

At 212, method 200 includes fine-tuning the student model using direct preference optimization based on the dataset. The method 200 can use a system operatively coupled to the processor (e.g., tuning component 114) to fine-tune the student model using direct preference optimization based on the dataset.

In some embodiments, method 200 is performed by a system, such as system 100 of FIG. 1. The prompting a student model to generate multiple code responses, each comprising a candidate solution to a given coding task 202 can be performed by a code generation component (e.g., code generation component 102 of FIG. 1). The utilizing a teacher model to assess correctness of each of the code responses 204 can be performed by an evaluation component (e.g., evaluation component 106). Introducing errors into correct code responses to generate corresponding incorrect versions 206 can be performed by a feedback component (e.g., feedback component 110). The rectifying incorrect code responses to generate corresponding correct versions 208 can be performed by a feedback component (e.g., feedback component 110). Compiling the correct and incorrect versions into a dataset of code pairs 210 can be performed by a pairing component (e.g., pairing component 112). Fine-tuning the student model using direct preference optimization based on the dataset 312 can be performed by a tuning component (e.g., tuning component 114).

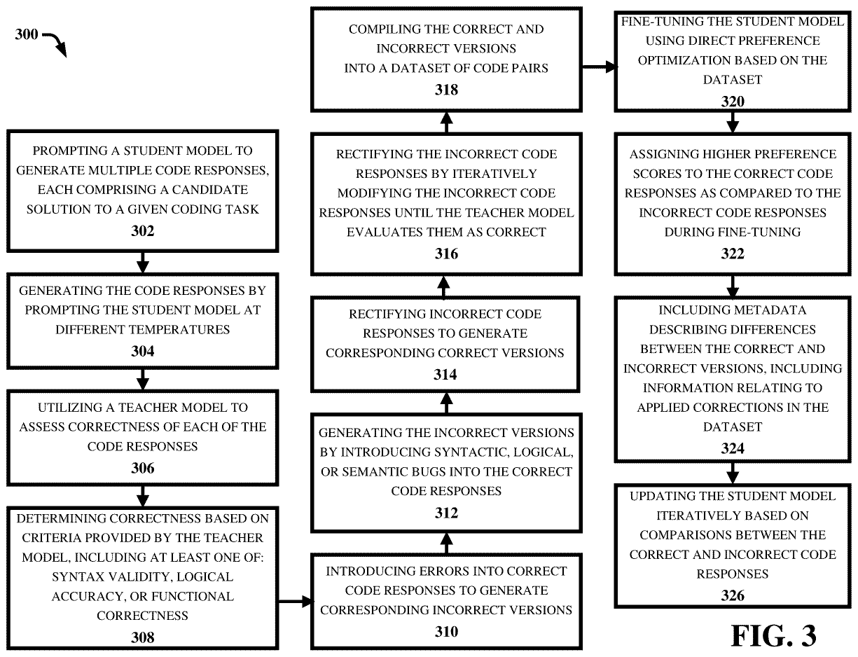

Next, FIG. 3 illustrates a flow diagram of a method 300 that can facilitate refinement of code generated by large language models in accordance with some embodiments described herein. While the method 300 is described relative to the system 100 of FIG. 1, the method 300 can be applicable also to other systems described herein.

At 302, the method 300 includes prompting a student model to generate multiple code responses, each comprising a candidate solution to a given coding task. The method 300 can use a system operatively coupled to the processor (e.g., code generation component 102) to prompt a student model to generate multiple code responses, each comprising a candidate solution to a given coding task. According to various embodiments, the student model can be fine-tuned using reinforcement learning techniques to maximize its ability to generate correct code responses

At 304, method 300 includes generating the code responses by prompting the student model at different temperatures. The method 300 can use a system operatively coupled to the processor (e.g., code generation component 102) to generate the code responses by prompting the student model at different temperatures.

At 306, method 300 includes utilizing a teacher model to assess correctness of each of the code responses. The method 300 can use a system operatively coupled to the processor (e.g., evaluation component 106) to utilize a teacher model to assess correctness of each of the code responses. In various embodiments, the teacher model is a larger pre-trained language model that provides evaluations and modifications without requiring explicit test cases or compiler execution.

At 308, method 400 includes determining correctness based on criteria provided by the teacher model, including at least one of: syntax validity, logical accuracy, or functional correctness. The method 300 can use a system operatively coupled to the processor (e.g., evaluation component 106) to determine correctness based on criteria provided by the teacher model, including at least one of: syntax validity, logical accuracy, or functional correctness.

At 310, method 300 includes introducing errors into correct code responses to generate corresponding incorrect versions. The method 300 can use a system operatively coupled to the processor (e.g., feedback component 110) to introduce errors into correct code responses to generate corresponding incorrect versions.

At 312, method 300 includes generating the incorrect versions by introducing syntactic, logical, or semantic bugs into the correct code responses. The method 300 can use a system operatively coupled to the processor (e.g., feedback component 110) to generate the incorrect versions by introducing syntactic, logical, or semantic bugs into the correct code responses.

At 314, method 300 includes rectifying incorrect code responses to generate corresponding correct versions. The method 300 can use a system operatively coupled to the processor (e.g., feedback component 110) to rectify incorrect code responses to generate corresponding correct versions.

At 316, method 300 includes rectifying the incorrect code responses by iteratively modifying the incorrect code responses until the teacher model evaluates them as correct. The method 300 can use a system operatively coupled to the processor (e.g., feedback component 110) to rectify the incorrect code responses by iteratively modifying the incorrect code responses until the teacher model evaluates them as correct.

At 318, method 300 includes compiling the correct and incorrect versions into a dataset of code pairs. The method 300 can use a system operatively coupled to the processor (e.g., pairing component 112) to compile the correct and incorrect versions into a dataset of code pairs.

At 320, method 300 includes fine-tuning the student model using direct preference optimization based on the dataset. The method 300 can use a system operatively coupled to the processor (e.g., tuning component 114) to fine-tune the student model using direct preference optimization based on the dataset.

At 322, method 300 includes assigning higher preference scores to the correct code responses as compared to the incorrect code responses during fine-tuning. The method 300 can use a system operatively coupled to the processor (e.g., tuning component 114) to assign higher preference scores to the correct code responses as compared to the incorrect code responses during fine-tuning.

At 324, method 300 includes including metadata describing differences between the correct and incorrect versions, including information relating to applied corrections in the dataset. The method 300 can use a system operatively coupled to the processor (e.g., tuning component 114) to include metadata describing differences between the correct and incorrect versions, including information relating to applied corrections in the dataset.

At 326, method 300 includes updating the student model iteratively based on comparisons between the correct and incorrect code responses. The method 300 can use a system operatively coupled to the processor (e.g., tuning component 114) to update the student model iteratively based on comparisons between the correct and incorrect code responses.

One or more systems, devices, computer program products, and/or computer-implemented methods provided herein relate to refinement of generated code models. A system can include a processor that executes computer executable components stored in memory. The computer executable components can include a code generation component that prompts a student model to generate multiple code responses, each comprising a candidate solution to a given coding task. The computer executable components can further include an evaluation component that utilizes a teacher model to assess correctness of each of the code responses. The computer executable components can further include a feedback component that introduces errors into correct code responses to generate corresponding incorrect versions, and rectifies incorrect code responses to generate corresponding correct versions. The computer executable components can include a pairing component that compiles the correct and incorrect versions into a dataset of code pairs. The computer executable include can further comprise a tuning component that fine-tunes the student model using direct preference optimization based on the dataset.

Advantages of this system can include enabling more efficient training of smaller large language models through feedback, improving model accuracy without compiler-based validation, and lowering computational costs by avoiding repeated inference calls or multi-agent prompting during training.

In various embodiments, the student model can be fine-tuned using reinforcement learning techniques to maximize its ability to generate correct code responses. A reinforcement learning technique can include preference-based methods that use pairwise comparisons between code samples to guide optimization. In some embodiments, the teacher model can be a larger pre-trained language model that provides evaluations and modifications without requiring explicit test cases or compiler execution. A teacher model can operate without access to ground truth labels or unit tests, relying instead on its own internal evaluation criteria.

In various embodiments, the code generation component can generate the code responses by prompting the student model at different temperatures. Temperature values can be sampled from a predefined range to introduce variation in an output. In some embodiments, a fixed number of samples can be generated per prompt, while in other embodiments the number can vary dynamically based on task complexity or confidence scores.

In some embodiments, the evaluation component can determine correctness based on criteria provided by the teacher model, including at least one of: syntax validity, logical accuracy, or functional correctness. Correctness can be determined without executing code, relying instead on static or inferred properties. In various embodiments, evaluation can be based on natural language reasoning capabilities of the teacher model, which can identify likely semantic errors or omissions.

In various embodiments, the feedback component can generate the incorrect versions by introducing syntactic, logical, or semantic bugs into the correct code responses. In certain embodiments, the bug generation can be guided by prompting a teacher model to introduce a specific number or type of errors. In some embodiments, the feedback component can rectify the incorrect code responses by iteratively modifying the incorrect code responses until the teacher model evaluates them as correct. The rectification loop can be repeated until a correctness condition is satisfied, such as an affirmative evaluation from a teacher model.

In some embodiments, the tuning component can assign higher preference scores to the correct code responses as compared to the incorrect code responses during fine-tuning. Preference scores can be computed based on relative likelihoods, learned reward functions, or contrastive learning objectives. According to various embodiments, the dataset can include metadata describing differences between the correct and incorrect versions, including information relating to applied corrections. Metadata can be used to track transformation steps and can support interpretability or future model analysis. In various embodiments, the tuning component can update the student model iteratively based on comparisons between the correct and incorrect code responses. Fine-tuning can be performed using direct preference optimization to align the student model's outputs with those preferred by a teacher model.

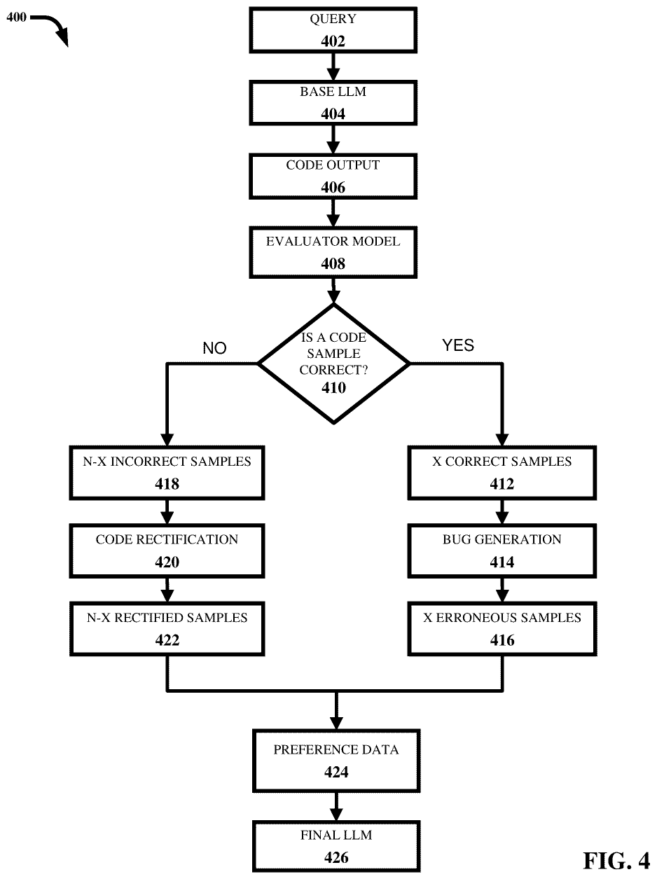

FIG. 4 illustrates an example architecture for training a language model using feedback-based refinement in accordance with some of the embodiments described herein.

At 402, a query can be received and used to generate multiple code responses outputs through temperature sampling. A set of sample prompts can be processed by a base language model at block 404, which can output a plurality of code responses at block 406.

Generated code responses can be evaluated at block 408 using an evaluation model (e.g., a teacher model). At decision block 410, a determination is made as to whether a given code response is correct. If the response is determined to be correct, control flows to block 412, where x correct samples are collected. These correct samples can be further processed at block 414, where a bug generation component can introduce controlled modifications to produce x corresponding erroneous code samples at block 416.

If a response is determined to be incorrect at decision block 410, control flows to block 418, where n−x incorrect code samples can be collected. Incorrect samples can be processed by a code rectification component at block 420 to generate n−x corrected versions at block 422.

Erroneous samples from block 416 and rectified samples from block 422 can be compiled into preference data at block 424. The preference data can comprise a set of n paired examples, each pair including a correct and an incorrect version of code. Preference data is then can be used to perform training of the base language model using direct preference optimization (DPO), resulting in a fine-tuned model at block 426.

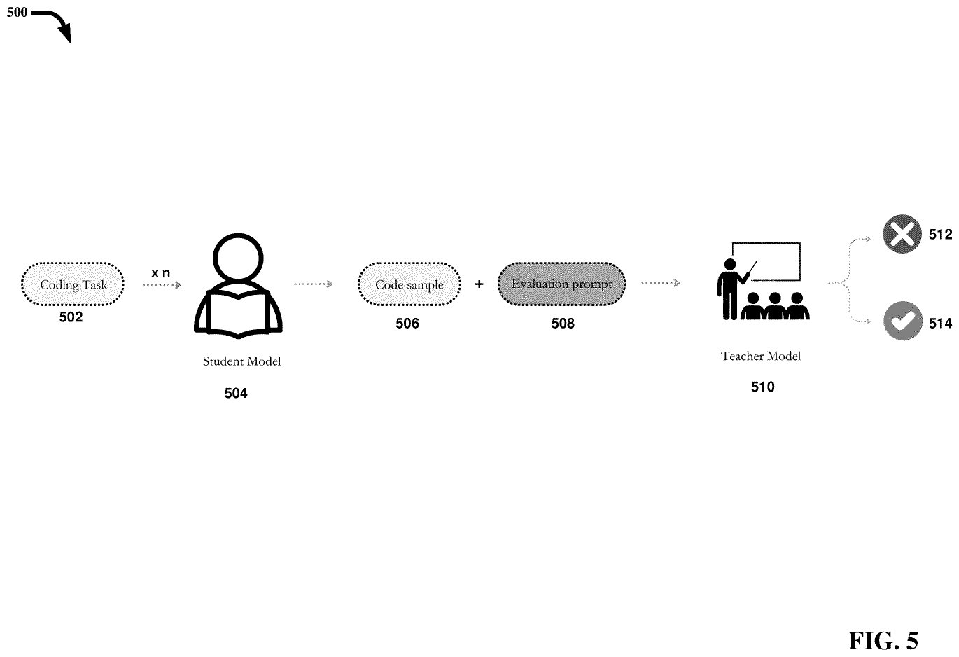

FIG. 5 illustrates an example process flow 500 for code sample generation and evaluation, in accordance with one or more embodiments described herein.

In FIG. 5, It the student model, Π represents the teacher model, Γ denotes the dataset of coding tasks, τ∈Γ represents an individual coding task, n indicates the number of sampled code responses per task, and each response is evaluated for correctness by the teacher model. FIG. 5 illustrates a detailed view of the code generation and evaluation process, corresponding to steps 402 (task/query input), 404 (student model), 406 (code sample output), 408 (evaluation by teacher model), 410 (correctness check), 412 (correct classification), and 418 (incorrect classification) as shown in FIG. 4.

As shown, a coding task is selected from a task dataset Γ at block 502, wherein each task τ∈Γ represents a coding task or instruction intended to elicit code output.

At block 504, the student model can be prompted n times, each at a different temperature setting, to generate a diverse set of n code responses corresponding to task, τ. Each code response 506 can then be paired with its respective task to form an evaluation prompt at block 508.

At block 510, the evaluation prompt can be input to a teacher model (e.g., a larger language model, II), which assesses the functional correctness of each code response. Based on this evaluation, each code sample can be classified as either correct (e.g., block 510) or incorrect (e.g., block 512), thereby producing labeled feedback without reliance on ground truth outputs or test cases.

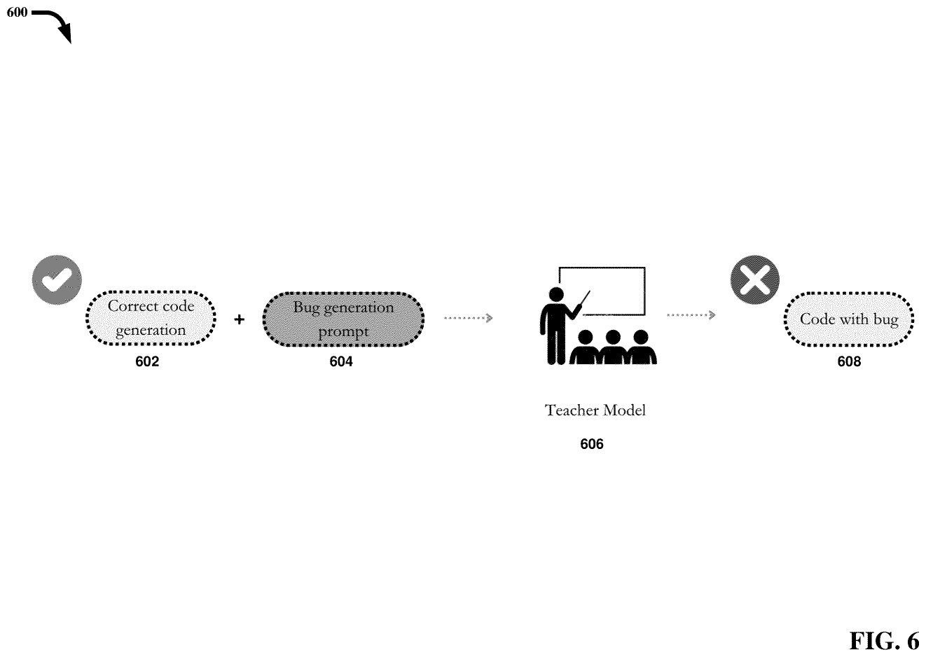

FIG. 6 illustrates an example process 600 for bug generation and incorrect code synthesis, corresponding to the correct-code flow shown in blocks 412, 414, and 416 of FIG. 4, in accordance with one or more embodiments.

Block 602 represents a code sample previously evaluated as correct by the teacher model. This correct code can be paired with a bug generation prompt at block 604, which instructs the system to introduce one or more semantic or syntactic errors.

The bug generation prompt 604 and the correct code sample 602 can be provided as input to the teacher model, Π, at block 606. The teacher model can process this input and generate a modified version of the code that includes intentional bugs at block 608. The resulting erroneous code sample serves as a corresponding incorrect version of the original correct code.

The correct code and its generated incorrect counterpart can together form a labeled pair for use in a preference dataset, which enables training of the student model using direct preference optimization, as further illustrated in subsequent figures.

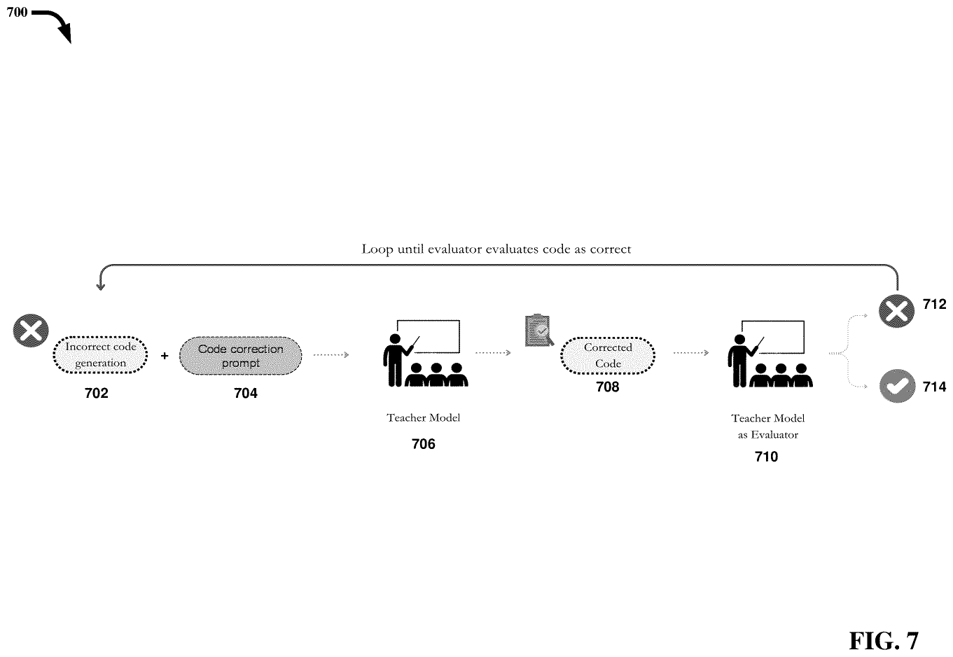

FIG. 7 illustrates an example process 700 for code rectification and iterative correction of incorrect code samples, in accordance with one or more embodiments. FIG. 7 corresponds to blocks 418, 420, and 422 of FIG. 4, which represent the handling and refinement of initially incorrect code responses.

At block 702, a code sample previously evaluated as incorrect can be selected for rectification. This sample can be combined with a code correction prompt at block 704, instructing the system to revise the erroneous code to make it functionally correct. The prompt and incorrect code can be inputted to the teacher model, II, at block 706, which attempts to generate a corrected version of the code at block 708.

The modified code sample can then be passed to the evaluation component (e.g., teacher model acting as an evaluator) at block 710. If the teacher model still evaluates the sample as incorrect, control can flow to block 712, and the rectification process loops back to block 704 for further refinement. This loop continues iteratively until the code sample is evaluated as correct, at which point control flows to block 714.

Once a corrected code version is confirmed to be functionally correct by the evaluator, the original incorrect sample and its rectified counterpart can form a labeled pair for inclusion in the preference dataset. These pairs can be used for training the student model using direct preference optimization.

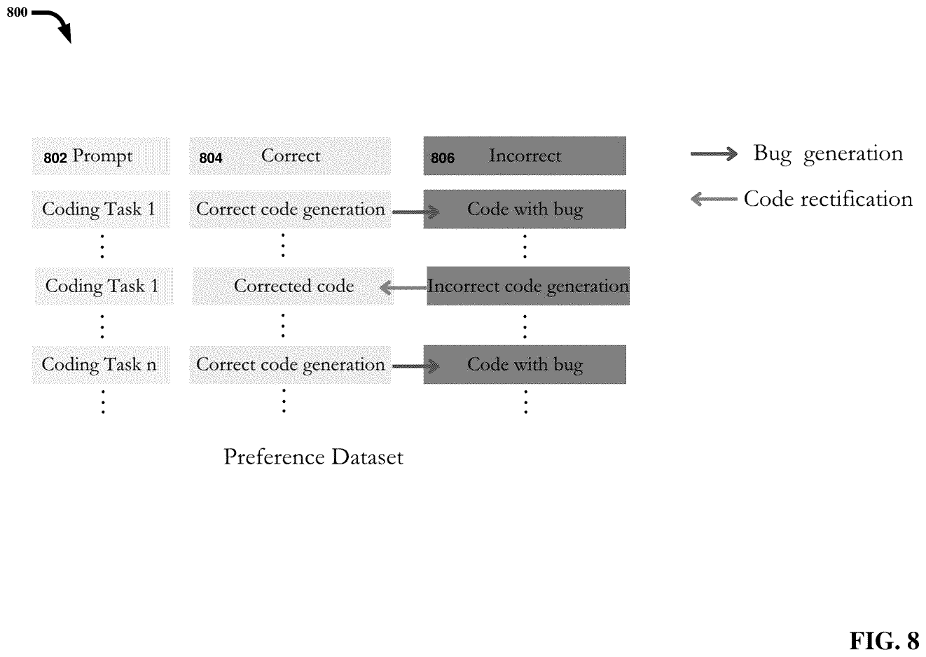

FIG. 8 illustrates an example process 800 for preference dataset creation and model fine-tuning using direct preference optimization (DPO), in accordance with one or more embodiments. The figure represents the aggregation of data outputs from both the bug generation and code rectification stages (e.g., as described in FIGS. 6 and 7).

For each coding task, a correct code sample 804 can be paired with an incorrect version 806. As shown, correct samples 804 can originate from successful initial generation or from rectified incorrect responses, while an incorrect version 806 can be derived via bug injection or failed initial attempts. Arrows annotated with right facing arrow (→) represent bug generation (from correct to incorrect), and left facing arrows (←) represent code rectification (from incorrect to corrected).

Each row in the dataset can comprise a coding task prompt 802, a corresponding correct code sample 804, and its matched incorrect version 806, collectively forming a preference-labeled tuple. These tuples can be compiled into a preference dataset used for training.

The student model can be fine-tuned using direct preference optimization wherein the model can assign a higher likelihood or reward to a correct code sample relative to an incorrect one. This process can enable efficient training without requiring explicit scalar rewards, compiler feedback, or human annotation, and can result in a refined model that better distinguishes between high- and low-quality code outputs.

The following DPO loss function can be used in the training procedure:

$${ℒ}_{DPO} ( {π}_{θ} ; {π}_{ref} ) = - {𝔼}_{( x , {y}_{w} , {y}_{l}} ) ∼ 𝒟 [ log σ ( β log \frac{{π}_{θ} ( {y}_{w} \vert x )}{{π}_{ref} ( {y}_{w} \vert x )} - β log \frac{{π}_{θ} ( {y}_{l} \vert x )}{{π}_{ref} ( {y}_{l} \vert x )} ) ]$$

The loss function can minimize the negative log-likelihood of the correct sample being preferred, as determined by comparing the output probabilities of the student model to those of a reference model.

The following reward modeling function can be used in the training procedure:

$$p * ( {y}_{1} ≻ {y}_{2} \vert x ) = \frac{exp ( r * ( x , {y}_{1} ) )}{exp ( r * ( x , {y}_{1} ) ) + exp ( r * ( x , {y}_{2} ) )}$$

The reward modeling function can compute a soft preference probability between two samples, allowing a model to learn preference structures even in the absence of explicit evaluation metrics.

Together, these formulations can enable effective alignment of the student model's behavior with desired coding patterns using only relative preference data.

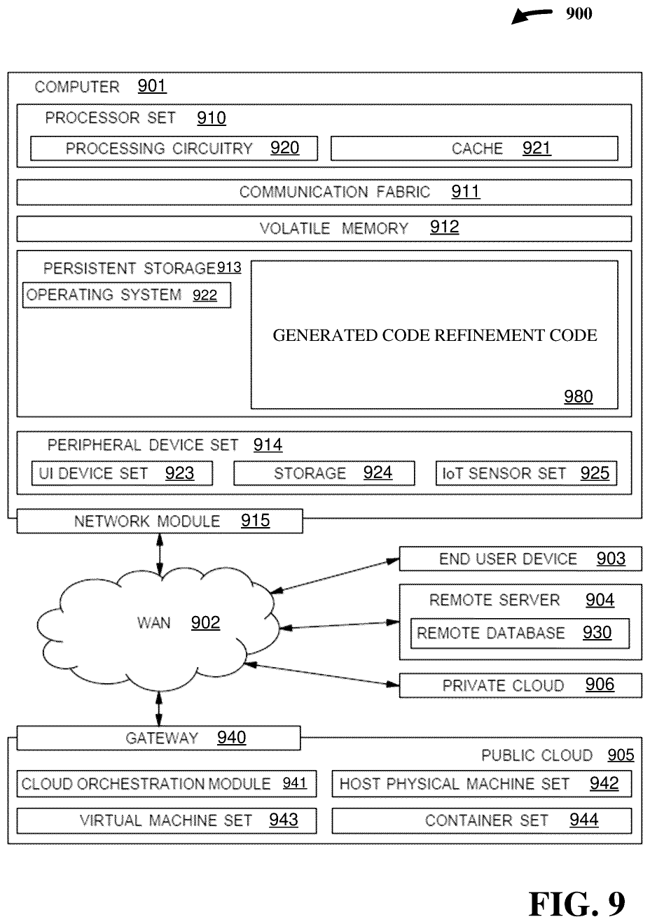

FIG. 9 and the following discussion are intended to provide a brief, general description of a suitable computing environment 900 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as generated code refinement code 980. In addition to block 980, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 980, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method can be distributed among multiple computers and/or between multiple locations. On the other hand, in this presentation of computing environment 900, detailed discussion is focused on a single computer, specifically computer 901, to keep the presentation as simple as possible. Computer 901 can be located in a cloud, even though it is not shown in a cloud in FIG. 9. On the other hand, computer 901 is not required to be in a cloud except to any extent as can be affirmatively indicated.

PROCESSOR SET 910 includes one, or more, computer processors of any type now known or to be developed in the future. Processing circuitry 920 can be distributed over multiple packages, for example, multiple, coordinated integrated circuit chips. Processing circuitry 920 can implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set can be located “off chip.” In some computing environments, processor set 910 can be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods can be stored in block 980 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory can be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 can be a read only memory (ROM), but typically at least a portion of the persistent storage allows writing of data, deletion of data and re-writing of data. Some familiar forms of persistent storage include magnetic disks and solid-state storage devices. Operating system 922 can take several forms, such as various known proprietary operating systems or open-source Portable Operating System Interface type operating systems that employ a kernel. The code included in block 980 typically includes at least some of the computer code involved in performing the inventive methods.

PERIPHERAL DEVICE SET 914 includes the set of peripheral devices of computer 901. Data communication connections between the peripheral devices and the other components of computer 901 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 can include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 can be persistent and/or volatile. In some embodiments, storage 924 can take the form of a quantum computing storage device for storing data in the form of qubits. In embodiments where computer 901 is required to have a large amount of storage (for example, where computer 901 locally stores and manages a large database) then this storage can be provided by peripheral storage devices designed for storing large amounts of data, such as a storage area network (SAN) that is shared by multiple, geographically distributed computers. IoT sensor set 925 is made up of sensors that can be used in Internet of Things applications. For example, one sensor can be a thermometer, and another sensor can be a motion detector.

NETWORK MODULE 915 is the collection of computer software, hardware, and firmware that allows computer 901 to communicate with other computers through WAN 902. Network module 915 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and can take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 can be a client device, such as thin client, heavy client, mainframe computer and/or desktop computer.

REMOTE SERVER 904 is any computer system that serves at least some data and/or functionality to computer 901. Remote server 904 can be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data can be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (V CEs) typically take the form of virtual machines from virtual machine set 943 and/or containers from container set 944. It is understood that these VCEs can be stored as images and can be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware and firmware allowing public cloud 905 to communicate through WAN 902.

Some further explanation of virtualized computing environments (V CEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. M any modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a code generation component that prompts a student model to generate multiple code responses, each comprising a candidate solution to a given coding task;
an evaluation component that utilizes a teacher model to assess correctness of each of the code responses;
a feedback component that introduces errors into correct code responses to generate corresponding incorrect versions, and rectifies incorrect code responses to generate corresponding correct versions;
a pairing component that compiles the correct and incorrect versions into a dataset of code pairs; and
a tuning component that fine-tunes the student model using direct preference optimization based on the dataset.

2. The system of claim 1, wherein the code generation component generates the code responses by prompting the student model at different temperatures.

3. The system of claim 1, wherein the evaluation component determines correctness based on criteria provided by the teacher model, including at least one of: syntax validity, logical accuracy, or functional correctness.

4. The system of claim 1, wherein the feedback component generates the incorrect versions by introducing syntactic, logical, or semantic bugs into the correct code responses.

5. The system of claim 1, wherein the feedback component rectifies the incorrect code responses by iteratively modifying the incorrect code responses until the teacher model evaluates them as correct.

6. The system of claim 1, wherein the tuning component assigns higher preference scores to the correct code responses as compared to the incorrect code responses during fine-tuning.

7. The system of claim 1, wherein the dataset includes metadata describing differences between the correct and incorrect versions, including information relating to applied corrections.

8. The system of claim 1, wherein the student model is fine-tuned using reinforcement learning techniques to maximize its ability to generate correct code responses.

9. The system of claim 1, wherein the teacher model is a larger pre-trained language model that provides evaluations and modifications without requiring explicit test cases or compiler execution.

10. The system of claim 1, wherein the tuning component updates the student model iteratively based on comparisons between the correct and incorrect code responses.

11. A computer-implemented method that utilizes a processor that executes computer executable components stored in memory to perform the following acts:
prompting a student model to generate multiple code responses, each comprising a candidate solution to a given coding task;
utilizing a teacher model to assess correctness of each of the code responses;
introducing errors into correct code responses to generate corresponding incorrect versions;
rectifying incorrect code responses to generate corresponding correct versions;
compiling the correct and incorrect versions into a dataset of code pairs; and
fine-tuning the student model using direct preference optimization based on the dataset.

12. The method of claim 11, further comprising generating the code responses by prompting the student model at different temperatures.

13. The method of claim 11, further comprising determining correctness based on criteria provided by the teacher model, including at least one of: syntax validity, logical accuracy, or functional correctness.

14. The method of claim 11, further comprising generating the incorrect versions by introducing syntactic, logical, or semantic bugs into the correct code responses.

15. The method of claim 11, further comprising rectifying the incorrect code responses by iteratively modifying the incorrect code responses until the teacher model evaluates them as correct.

16. The method of claim 11, further comprising assigning higher preference scores to the correct code responses as compared to the incorrect code responses during fine-tuning.

17. The method of claim 11, further comprising including metadata describing differences between the correct and incorrect versions, including information relating to applied corrections.

18. The method of claim 11, further comprising fine-tuning the student model using reinforcement learning techniques to maximize its ability to generate correct code responses.

19. The method of claim 11, further comprising updating the student model iteratively based on comparisons between the correct and incorrect code responses.

20. A computer program product comprising a computer readable storage medium having program instructions embodied therewith, the program instructions executable by a processor to cause the processor to:
prompt a student model to generate multiple code responses, each comprising a candidate solution to a given coding task;
utilize a teacher model to assess correctness of each of the code responses;
introduce errors into correct code responses to generate corresponding incorrect versions;
rectify incorrect code responses to generate corresponding correct versions;
compile the correct and incorrect versions into a dataset of code pairs; and
fine-tune the student model using direct preference optimization based on the dataset.
